(19) United States
(12) Patent Application Publication
(10) Pub. No.: US 2021/0213965 A1
(43) Pub. Date: Jul. 15, 2021

(54) OPERATING METHOD AND CONTROL UNIT FOR A DATA/SIGNAL EVALUATION SYSTEM, DATA/SIGNAL EVALUATION SYSTEM, ULTRASOUND OPERATION ASSISTANCE SYSTEM AND WORKING DEVICE

(71) Applicant: Robert Bosch GmbH, Stuttgart (DE)

(72) Inventors: Christian Waeltring, Oferdingen (DE); Markus Brockmann, Moessingen (DE); Axel Wenzler, Rottweil (DE)

(21) Appl. No.: 17/271,527

(22) PCT Filed: Jul. 23, 2019
(86) PCT No.: PCT/EP2019/069806

§ 371 Date: Mar. 30, 2021

(30) Foreign Application Priority Data
Sep. 6, 2018 (DE) 102018215139.3

(51) Int. Cl. B60W 50/04; G01S 7/527; G01S 15/931; H04B 11/00

(52) U.S. Cl. CPC B60W 50/04; G01S 7/527; B60W 2420/54; H04B 11/00; G01S 15/931

(57) ABSTRACT

An operating method for a data/signal evaluation system in an ultrasonic operation assistance system, in which a plurality of digital signal-processing processors is developed in a sequential pipeline for the evaluation of data and/or signals, including a first operating mode for processing tasks requiring a comparatively greater processing effort with a comparatively greater measure of processing power to be generated by the digital signal-processing processors, and having a second operating mode for processing tasks requiring a comparatively lower processing effort with a comparatively lower measure of processing power to be generated by the digital signal-processing processors. In the first operating mode, the digital signal-processing processors of the sequential pipeline are operated in parallel with each other, and in the second operating mode at least one pair of the plurality of signal-processing processors of the sequential pipeline is operated sequentially.

### FIELD

The present invention relates to an operating method and to a control unit for a data/signal evaluation system, a data/signal evaluation system, an ultrasonic operation assistance system, and to a working device, and especially a vehicle.

### BACKGROUND INFORMATION

In many working devices and in particular in the automotive field, sensors for detecting signals and corresponding data/signal evaluation systems for evaluating the detected signals are used on a regular basis. For example, this applies to sensors in connection with the detection of an environment of the working device such as those used in connection with ultrasonic driver-assistance systems in vehicles, but other application fields are possible as well.

One problem in such operating environments is that underlying data/signal evaluation systems generate interference signals because of the operation of the digital signal-processing processors included in these systems and their usually adopted power-distribution strategies, e.g., in connection with a duty cycle operation; the interference signals then in turn act on the underlying sensor system or on other analog components and may cause operating errors.

### SUMMARY

An operating method according to an example embodiment of the present invention for a data/signal evaluation system may have the advantage that interference signals related to current peaks are reduced or avoided. According to an example embodiment of the present invention, this is achieved by providing an operating method for a data/signal evaluation system, in particular in an ultrasonic operation assistance system, in which a plurality of digital signal-processing processors is developed in a sequential pipeline for the purpose of a data and/or signal evaluation. The operating method according to the present invention has a first operating mode for processing tasks that require a comparatively greater processing effort with a comparatively greater measure of processing power to be generated by the digital signal-processing processors, and it also has a second operating mode for processing tasks that require a comparatively lower processing effort with a comparatively lower measure of processing power to be generated by the digital signal-processing processors. In the first operating mode, the digital signal-processing processors of the sequential pipeline are operated in parallel. In the second operating mode, at least one pair of the plurality of digital signal-processing processors of the sequential pipeline is operated in sequence. The measures provided according to the present invention have the result that due to the temporal separation of the power withdrawal by the signal-processing processors at least in the second operating mode, normally arising current peaks and the related interference signals are at least reduced.

Preferred further refinements of the present invention are described herein.

In one further refinement of the operating method according to an example embodiment of the present invention, in the second operating mode, a digital signal-processing processor of the pair to be operated subsequently is at least intermittently kept in a rest mode, while a digital signal-processing processor of the pair to be operated in advance is operated in advance in the normal manner.

According to another preferred embodiment of the operating method of the present invention, the occurring current peaks and thus potential interference signals are able to be further reduced if in the second operating mode a digital signal-processing processor of the pair to be operated subsequently is at least intermittently operated in an idle mode, while a digital signal-processing processor of the pair to be operated in advance is operated in the normal manner in advance.

As an alternative or in addition, for a further reduction of current peaks and interference signals, it may be provided that in the second operating mode, a digital signal-processing processor of the pair to be operated in advance is at least intermittently operated in an idle mode and/or is at least intermittently kept in a rest mode, while a digital signal-processing processor of the pair to be operated subsequently is subsequently operated in the normal manner.

The operating strategy provided according to example embodiments of the present invention is able to be used to particular advantage especially in structures and operating methods in which a digital signal-processing processor to be operated subsequently in the second operating mode processes data that were processed by a digital signal-processing processor to be operated in advance in the second operating mode.

In this context, it is particularly advantageous if a digital signal-processing processor to be operated subsequently in the second operating mode is coupled with a digital signal-processing processor to be operated in advance in the second operating mode via a FIFO memory for the buffered transmission of data of an output of the digital signal-processing processor to be operated in advance in the second operating mode, to an input of the digital signal-processing processor to be subsequently operated in the second operating mode.

The control of a start and/or an end of the first operating mode and/or the second operating mode is able to be linked with a specific application and a wide variety of conditions.

In particular, it is possible that
an operating segment of the method is started with the first operating mode;
the operation of the first operating mode is started when a first condition is satisfied;
during an operation a switch is made to the second operating mode as soon as the first operating mode is or was concluded;
during an operation the first operating mode is ended when a second condition is satisfied, and/or
during an operation the second operating mode is ended when a third condition is satisfied,
   wherein
for example, the second condition may be satisfied if a given first time span has elapsed since the start of the first operating mode, and/or
the third condition may be satisfied if a given second time span has elapsed since the start of the second operating mode.

According to a further aspect of the present invention, the operating method according to the present invention in particular is set up for the operation of an ultrasonic operation assistance system or an ultrasonic driver-assistance system of a working device and in particular a vehicle.

In this context, and especially in the context of the control of the first operating mode and the second operating mode, it may be provided that, for example,
the first condition is satisfied when an ultrasonic transmit signal is emitted and/or when a predefined third time span has elapsed since the emission of an ultrasonic transmit signal,
the first time span for the second condition is a time span t1 that is characteristic of a near field of the underlying working device, in particular typically in the range of a few 10 ms, and/or
the second time span for the third condition is a time span t2 that is characteristic of a far field of the underlying working device, in particular typically in the range of a few 100 ms after an emission of an ultrasonic transmit signal.

According to a further aspect of the present invention, a control unit for a data/signal evaluation system is provided as well, in particular in an ultrasonic operation assistance system. The control unit is set up to initiate, allow to run, and/or to control an embodiment of the operating method according to the present invention on an underlying data/signal evaluation system and in particular on an underlying ultrasonic operation assistance system.

In addition, a data/signal evaluation system, in particular in an ultrasonic operation assistance system, is a further subject matter of the present invention. The data/signal evaluation system is designed to carry out an embodiment of the operating method according to the present invention or to be used in an embodiment of the operating method according to the present invention.

Alternatively or additionally, in the data/signal evaluation system according to an example embodiment of the present invention, a control unit configured according to the present invention is developed.

Moreover, the present invention also provides an ultrasonic operation assistance system as such, which especially may be developed as an ultrasonic driver-assistance system. The ultrasonic operation assistance system is designed to carry out an embodiment of the operating method according to the present invention or to be used in an embodiment of the operating method according to the present invention.

Alternatively or additionally, the ultrasonic operation assistance system is characterized by being developed with a control unit configured according to the present invention and/or by being developed with a data/signal evaluation system configured according to the present invention.

In addition, the present invention also provides a working device, and in particular a vehicle having an operating unit and in particular a drive, which is developed with an ultrasonic operation assistance system, developed according to the present invention, for the control of the operating unit.

### BRIEF DESCRIPTION OF THE DRAWINGS

Example embodiments of the present invention are described in detail below with reference to the figures.

FIG. 1 illustrates in the form of a schematic block diagram an example embodiment of the data/signal evaluation system according to the present invention.

FIG. 2 illustrates in a graph the current load drawn in different operating modes in a digital signal-processing processor.

FIGS. 3 and 4 illustrate with the aid of graphs the advantages achievable according to an example embodiment of the present invention with regard to the signals to be detected, their signal-to-noise ratios and their production in connection with the current loads drawn by the involved digital signal-processing processors.

FIGS. 5 and 6 illustrate with the aid of graphs the conventional conditions in signals to be detected, their signal-to-noise ratios as well as their production in connection with the current loads drawn by the involved digital signal-processing processors.

### DETAILED DESCRIPTION OF EXAMPLE EMBODIMENTS

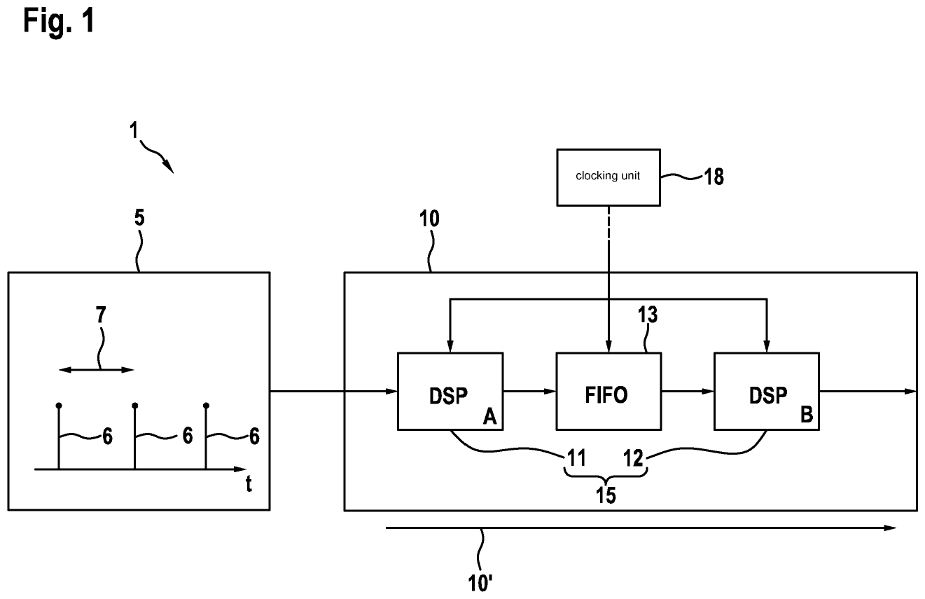

Below, exemplary embodiments of the present invention and the technical background are described in detail with reference to FIGS. 1 through 6. Identical and equivalent elements as well as identically or equivalently acting elements and components are denoted by the same reference numerals. The detailed description of the denoted elements and components is not addressed in every single occurrence of the elements and components.

The illustrated features and further characteristics are able to be used separately from one another and in any random combination without departing from the core of the present invention.

FIG. 1 illustrates an example embodiment of the data/signal evaluation system 1 according to the present invention in the form of a schematic block diagram.

Data/signal evaluation system 1 according to the present invention has a data source or signal source 5, for instance made up of one or multiple sensor(s) and a preprocessing unit, as the case may be. Data source 5, for example, outputs data 6 in the form of signals which are a function of time t, at a time interval 7.

Data 6 provided in this way are transferred to a processing pipeline 10 for further processing. Multiple digital signal-processing processors 11 and 12 are developed in pipeline 10 in a data-flow direction or processing direction 10′, which—adapted to one another—process supplied data 6.

In the embodiment shown in FIG. 1, a first digital signal-processing processor 11 ahead in data flow direction 10′, which is also denoted by reference sign “A” in connection with the following graphs, and a second digital signal-processing processor 12 following in data-flow direction 10′, which is also denoted by reference sign “B” in connection with the following graphs, are developed. The two signal-processing processors 11 and 12 form a pair 15 and are coupled with each other via an interconnected FIFO memory 13, FIFO memory 13 in particular serving as a buffer. In this way the second or following digital signal-processing processor is able to accept and further process the data processed and then output by the first or preceding digital signal-processing processor 11, via FIFO memory 13.

In the exemplary embodiment shown in FIG. 1, the flow of data 6 in data-flow direction 10′ as well as the processing in signal-processing processors 11, 12 of pair 15, and the storing in FIFO memory 13 are based on the clock of a clocking unit 18.

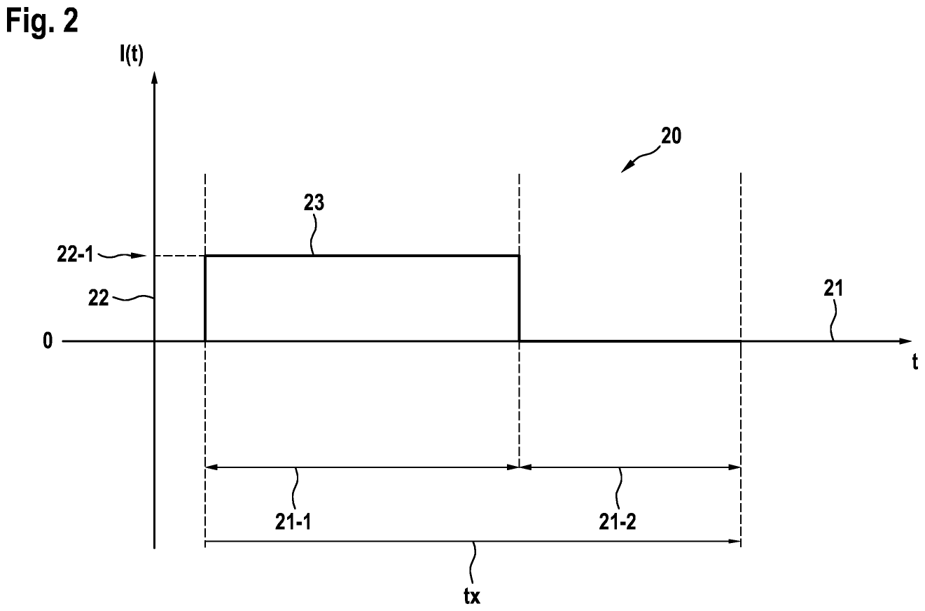

FIG. 2 illustrates, in the form of a graph 20, a current load 1(t) as a function of time t that occurs in digital signal-processing processor 11, 12 in the different operating phases, i.e. a current-intensive computation phase 22-1 having a maximum current 22-1, and a rest phase 21-2 with a current load 1(t) that occurs at a low current 1. Accordingly, in graph 20 the time has been plotted on abscissa 21, and the electrical current 1(t) drawn by processor 11, 12 is plotted on ordinate 22.

As described above in detail, a main feature of the present invention is the sequential operation of a pair 15 of digital signal-processing processors 11, 12 coupled with each other via a FIFO memory 13 in an operating mode that requires only a comparatively low processing effort. In one application, this could correspond to the data processing in an ultrasonic operation assistance system for the far field, in which objects from the environment of an underlying working device that are located at a greater distance are detected and the involved data quantity thus is lower but the signal levels are relatively low as well.

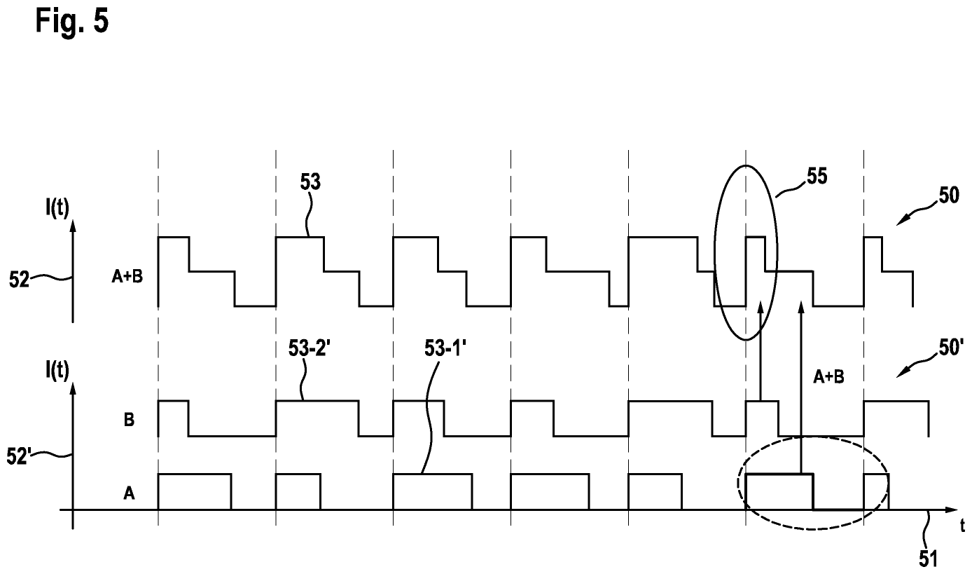

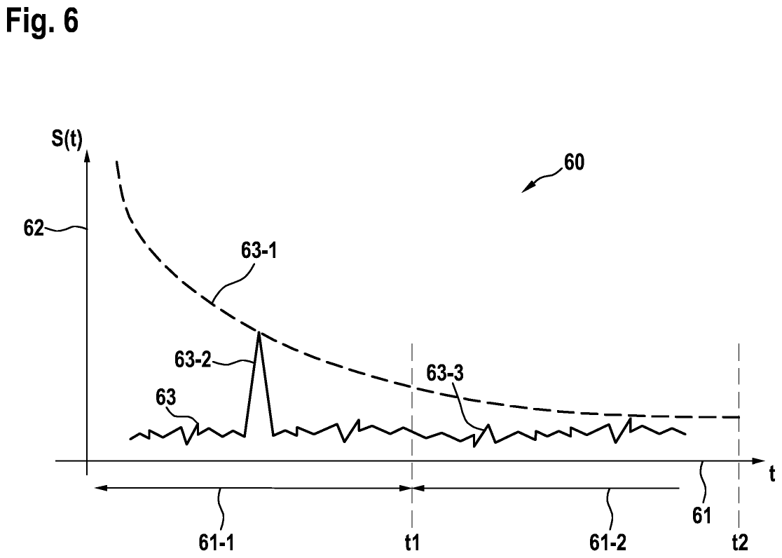

Before the advantages of the present invention are addressed, the conventional situation will be described with the aid of FIGS. 5 and 6. Using graphs 50, 50′ and 60, FIGS. 5 and 6 illustrate the conventional conditions in signals to be detected, their signal-to-noise ratios as well as their production in connection with current loads 1(t) drawn by involved digital signal-processing processors 11, 12.

In terms of its development, a conventional data/signal evaluation system essentially corresponds to the structure shown in FIG. 1, but the underlying operating method differs from the procedure according to the present invention.

Generally, as illustrated in connection with graph 50′, the operation of digital signal-processing processors 11, 12, which are denoted by A and B here, is carried out in parallel, in which case the two processors A and B are set to the operating mode or to the rest mode depending on the requirements. This is illustrated by the two tracks 53-1′ and 53-2′ of graph 50′ where time t is plotted on abscissa 51 and current load 1(t) is plotted on ordinate 52′. Both tracks show the operating mode featuring an increased current load and the rest mode featuring a negligible or reduced current load.

Graph 50 shows the sum total of the loads from graph 50′ for the two processors A, B by current load 1(t) plotted on ordinate 52 and time t in track 53 plotted on abscissa 51. According to the superposition, situations of a rapidly changing current load result at certain points, which are marked by reference numeral 55 in this instance and are also referred to as current peaks, with the result that interference signals in adjacent, especially analog, switching circuits are able to be induced.

As shown in connection with FIG. 6 and graph 60, such interference signals result in greater noise. The greater noise creates situations in which signals, e.g., in the ultrasonic application in the far field, are no longer detectable in an unambiguous manner because of the low signal level in comparison with the base noise.

In graph 60 of the figure, time t is plotted on abscissa 61 and signal amplitude S(t) is plotted on ordinate 62. From the characteristic of track 63 it can be gathered that conventionally determined signals 63-2, e.g., signals in near field 61-1 in an ultrasonic application, clearly project from the base noise and are able to be detected quite well, whereas other signals 63-3 such as signals in far field 61-2 in an ultrasonic application, are no longer detectable in an unambiguous manner because they have a characteristic that is virtually embedded in the base noise.

It is an object of the present invention to lower the base noise for situations in which low signal levels have to be anticipated, and to do so by a corresponding operating strategy. This is the usual situation in ultrasonic applications such as in the far field because the signal levels, in addition to the data quantity according to characteristic 63-1 from FIG. 6, scale with the distance, which is proportional to propagation time t.

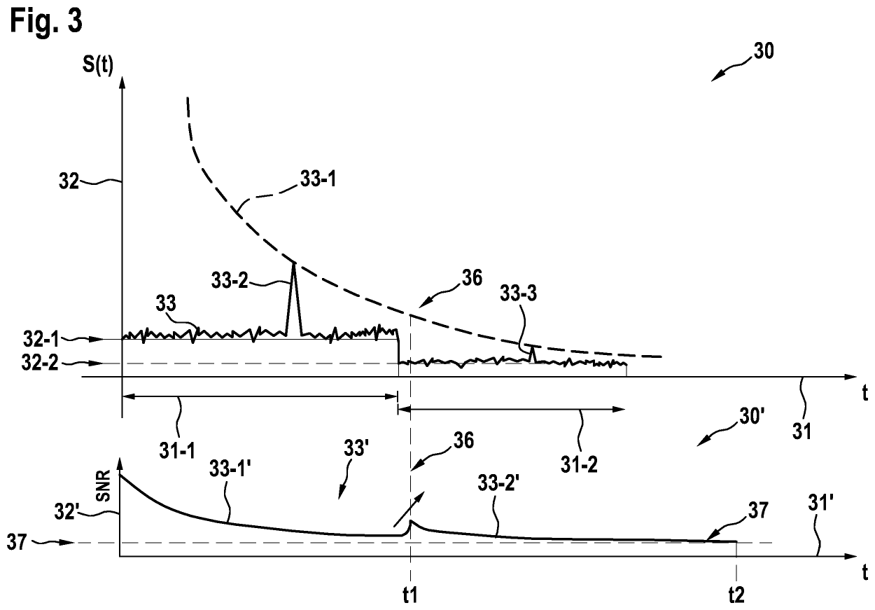

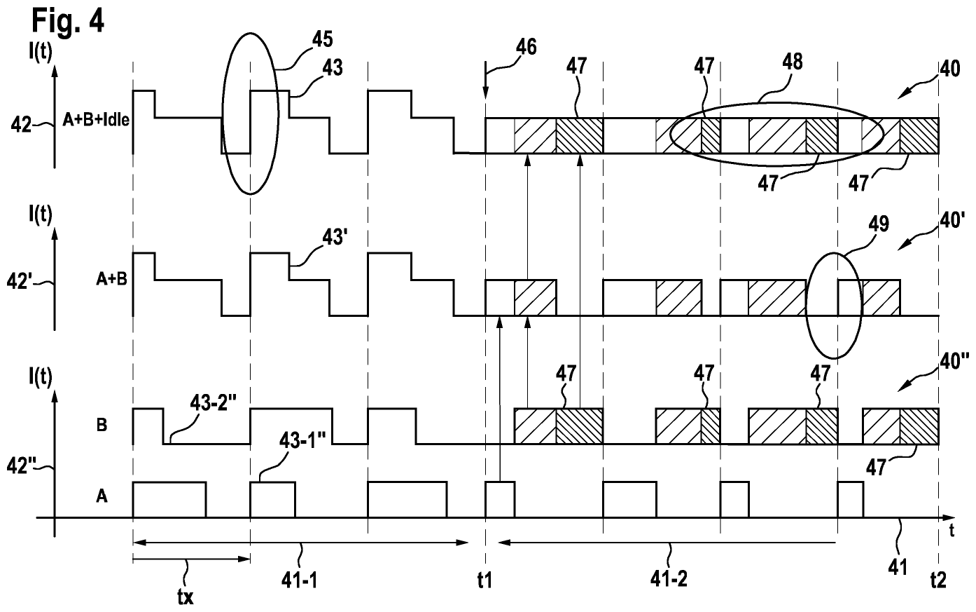

In this context, with the aid of graphs 30, 30′, 40, 40′, 40″, FIGS. 3 and 4 now illustrate the advantages able to be achieved according to the present invention with regard to signals S(t) to be detected, their signal-to-noise ratios SNR and their production in connection with the current loads 1(t) drawn by the involved digital signal-processing processors 11, 12.

To begin with, graph 40″ with the time plotted on abscissa 41 and current load 1(t) plotted on ordinate 42″, similar to FIG. 5, graph 50′ describes the operation of the two signal-processing processors 11, 12 of pair 15 denoted by A, B, i.e. once again based on the time characteristic of current load 1(t) in tracks 43-1″ and 43-2″.

In the first phase for the first operating mode, marked by 41-1, on abscissa 41, both processors A, B of sequential pipeline 10 are operated in parallel, similar to the conventional operating situation.

However, at switchover instant 46, the sequential operation of the two processors A, B ensues with the transition from the first operating mode to the second operating mode, first processor A initially assuming the processing in the different operating phases temporarily, and second processor B then taking over the processing. Moreover, in the time spans during which no computational output is called up for either processor A, B, an idle phase 47 may additionally be inserted for one of processors A, B; in this way, a current load level that is relatively constant as a whole is achieved with a further reduced share of interference signals because of the missing current peaks, as marked by region 48 in graph 40 for the sum of the current loads taking the idling process into account.

If an idling process is not taken into account for the phases in which none of the processors has to produce a computational output, then segments occur in the current load during which current peaks do occur in the form of interference signals, but they are clearly reduced in comparison with conventional operating methods, as may be gathered in connection with segment 49 of graph 40′ from FIG. 4.

Because of the operating scheme illustrated in FIG. 4, a signal characteristic as illustrated in connection with graphs 30 and 30′ from FIG. 3 is ultimately obtained.

Plotted on abscissas 31 and 31′ is time t, amplitude S(t) of the signal on ordinates 32, and the signal-to-noise ratio SNR on ordinates 32.

According to the present invention, because of the operating scheme illustrated in FIG. 4 for the two signal-processing processors 11, 12 denoted by A, B, unchanged conditions result for phase 31-1 in the near field in comparison with the situation shown in FIG. 6. This means that a signal 33-2 of track 33 in near field region 31-1 clearly projects beyond noise level 32-1 and is able to be detected in a satisfactory manner.

However, in contrast to the conventional conditions shown in FIG. 6, a clear reduction of the noise to a lower noise level 32-2 can be noticed with the transition to range 31-2 of the far field at switchover instant 36, 46 due to the omission of the current peaks. As a result, even signals 33-3 in the region of far field 31-2 featuring a lower signal level are able to be detected in a comparatively satisfactory manner, the signal levels once again following the theoretical amplitude characteristic 33-1 as a function of the object distance according to propagation time t.

Track 33′ describes the theoretical characteristic of signal-to-noise ratio SNR with segments 33-1′ and 33-2′ for range 31-1 of the near field and for range 31-2 of the far field with the transition to switchover instant 36, 46. Sketched is also the minimum signal-to-noise ratio 37 required for a reliable or sufficient detection.

1-12. (canceled)

13. An operating method for a data/signal evaluation system, in which a plurality of digital signal-processing processors is provided in a sequential pipeline for a data and/or signal evaluation, the method comprising:
in a first operating mode, processing tasks that require a comparatively greater processing effort with a comparatively greater measure of processing power to be generated by the digital signal-processing processors; and
in a second operating mode, processing tasks that require a comparatively lower processing effort with a comparatively lower measure of processing power to be generated by the digital signal-processing processors;
wherein:
in the first operating mode, the digital signal-processing processors of the sequential pipeline are operated in parallel; and
in the second operating mode, at least one pair of the plurality of digital signal-processing processors of the sequential pipeline is operated in sequence.

14. The operating method as recited in claim 13, wherein, in the second operating mode, a digital signal-processing processor of the pair to be operated subsequently is at least intermittently operated in an idle mode and/or is at least intermittently kept in a rest mode, while a digital signal-processing processor of the pair to be operated in advance is operated in a normal manner in advance.

15. The operating method as recited in claim 13, wherein, in the second operating mode, a digital signal-processing processor of the pair to be operated in advance is at least partly operated in an idle mode and/or is kept at least intermittently in a rest mode, while a digital signal-processing processor of the pair to be subsequently operated is subsequently operated in a normal manner.

16. The operating method as recited in claim 14, wherein, the digital signal-processing processor to be subsequently operated in the second operating mode processes data that were processed by the digital signal-processing processor to be operated in advance in the second operating mode.

17. The operating method as recited in claim 15, wherein, the digital signal-processing processor to be subsequently operated in the second operating mode processes data that were processed by the digital signal-processing processor to be operated in advance in the second operating mode.

18. The operating method as recited in claim 14, wherein the digital signal-processing data processor to be operated subsequently in the second operating mode is coupled with the digital signal-processing processor to be operated in advance in the second operating mode via a FIFO memory for a buffered transmission of data of an output of the digital signal-processing processor to be operated in advance in the second operating mode, to an input of the digital signal-processing processor to be subsequently operated in the second operating mode.

19. The operating method as recited in claim 15, wherein the digital signal-processing data processor to be operated subsequently in the second operating mode is coupled with the digital signal-processing processor to be operated in advance in the second operating mode via a FIFO memory for a buffered transmission of data of an output of the digital signal-processing processor to be operated in advance in the second operating mode, to an input of the digital signal-processing processor to be subsequently operated in the second operating mode.

20. The operating method as recited in claim 13, wherein:
an operating segment is started with the first operating mode, and/or
an operation of the first operating mode is started when a first condition is satisfied, and/or
during an operation, a switch is made to the second operating mode as soon as the first operating mode is or was ended, and/or
during an operation, the first operating mode is ended when a second condition is satisfied, and/or
during an operation, the second operating mode is ended when a third condition is satisfied,
wherein:
the second condition is satisfied when a given first time span has elapsed since the start of the first operating mode, and/or
the third condition is satisfied when a given second time span has elapsed since the start of the second operating mode.

21. The operating method as recited in claim 20, which is set up for operation of an ultrasonic operation assistance system or an ultrasonic driver-assistance system of a vehicle.

22. The operating method as recited in claim 21, wherein:
the first condition is satisfied when an ultrasonic transmit signal is emitted and/or when a predefined third time span has elapsed since an emission of an ultrasonic transmit signal, and/or
the first time span for the second condition is a time span that is characteristic of a near field of an underlying working device, and/or
the second time span for the third condition is a time span that is characteristic of a far field of the underlying working device after an emission of an ultrasonic transmit signal.

23. A control unit for a data/signal-evaluation system in an ultrasonic operation assistance system, the data/signal-evaluation system including a plurality of digital signal-processing processors provided in a sequential pipeline for a data and/or signal evaluation, the control unit configured to control the data/signal-evaluation system to:
in a first operating mode, process tasks that require a comparatively greater processing effort with a comparatively greater measure of processing power to be generated by the digital signal-processing processors; and
in a second operating mode, process tasks that require a comparatively lower processing effort with a comparatively lower measure of processing power to be generated by the digital signal-processing processors;
wherein:
in the first operating mode, the digital signal-processing processors of the sequential pipeline are operated in parallel; and
in the second operating mode, at least one pair of the plurality of digital signal-processing processors of the sequential pipeline is operated in sequence.

24. A data/signal evaluation system in an ultrasonic operation assistance system, including a plurality of digital signal-processing processors provided in a sequential pipeline for a data and/or signal evaluation, the data/signal-evaluation system configured to:
in a first operating mode, process tasks that require a comparatively greater processing effort with a comparatively greater measure of processing power to be generated by the digital signal-processing processors; and
in a second operating mode, process tasks that require a comparatively lower processing effort with a comparatively lower measure of processing power to be generated by the digital signal-processing processors;
wherein:
in the first operating mode, the digital signal-processing processors of the sequential pipeline are operated in parallel; and
in the second operating mode, at least one pair of the plurality of digital signal-processing processors of the sequential pipeline is operated in sequence.

25. An ultrasonic operation assistance system, comprising:
a plurality of digital signal-processing processors provided in a sequential pipeline for a data and/or signal evaluation, the digital signal-processing processors configured to:
in a first operating mode, process tasks that require a comparatively greater processing effort with a comparatively greater measure of processing power to be generated by the digital signal-processing processors; and
in a second operating mode, process tasks that require a comparatively lower processing effort with a comparatively lower measure of processing power to be generated by the digital signal-processing processors;
wherein:
in the first operating mode, the digital signal-processing processors of the sequential pipeline are operated in parallel; and
in the second operating mode, at least one pair of the plurality of digital signal-processing processors of the sequential pipeline is operated in sequence.

26. A vehicle, comprising:
an operating unit with a drive, which is developed with an ultrasonic operation assistance system for the control of the operating unit, the ultrasonic operation assistance system including:
a plurality of digital signal-processing processors provided in a sequential pipeline for a data and/or signal evaluation, the digital signal-processing processors configured to:
in a first operating mode, process tasks that require a comparatively greater processing effort with a comparatively greater measure of processing power to be generated by the digital signal-processing processors; and
in a second operating mode, process tasks that require a comparatively lower processing effort with a comparatively lower measure of processing power to be generated by the digital signal-processing processors;
wherein:
in the first operating mode, the digital signal-processing processors of the sequential pipeline are operated in parallel; and
in the second operating mode, at least one pair of the plurality of digital signal-processing processors of the sequential pipeline is operated in sequence.
